(19) United States
(12) Patent Application Publication
(10) Pub. No.: US 2025/0062313 A1
(43) Pub. Date: Feb. 20, 2025

(54) TENSION MECHANISM AND METHOD FOR MANUFACTURE OF AN ELECTRODE

(71) Applicant: Solid Power Operating, Inc., Louisville, CO (US)

(72) Inventor: Luke Anderson, Arvada, CO (US)

(21) Appl. No.: 18/807,559

(22) Filed: Aug. 16, 2024

Related U.S. Application Data
(60) Provisional application No. 63/533,250, filed on Aug. 17, 2023.

(51) Int. Cl. H01M 4/04; H01M 10/04

(52) U.S. Cl. CPC H01M 4/0435; H01M 10/0468

(57) ABSTRACT

Aspects involve systems and methods for producing an electrode laminate for a battery that includes a tension device to maintain tension on an electrode stack as the stack is cut into a shape. The tension device may include a first roller and a second. The upper roller may rotate in a counterclockwise direction as the lower roller rotates in a clockwise direction to pull or otherwise draw a skeleton of a cut stack through the tension device. A collection of spaced flexible and resilient flaps may be connected to the upper roller and may rotate with the upper roller. A contacting edge of each of the flaps may contact the skeleton of the stack and gently pull the skeleton through the tension device providing a relatively continuous pull on the stack as it proceeds through a cutting station.

### CROSS-REFERENCE TO RELATED APPLICATION

This application is related to and claims priority under 35 U.S.C. § 119 (e) from U.S. Patent Application No. 63/533,250, filed Aug. 17, 2023, titled “Tension Mechanism and Method for Manufacture of an Electrode,” the entire contents of which is incorporated herein by reference for all purposes.

### TECHNICAL FIELD

Various embodiments described herein relate to the field of solid-state primary and secondary electrochemical cells, electrodes, and electrode materials, and the corresponding methods of making and using the same.

### BACKGROUND AND INTRODUCTION

The ever-increasing number and diversity of mobile devices, the evolution of hybrid/electric automobiles, and the development of Internet-of-Things devices, among other things, is driving ever greater need for battery technologies with improved reliability, capacity, thermal characteristics, lifetime and recharge performance. Currently, although lithium solid-state battery technologies offer potential increases in safety, packaging efficiency, and enable new high-energy chemistries as compared to other types of batteries, improvements in battery technologies generally and particularly solid-state battery technologies are needed, including improvements in production efficiency.

It is with these observations in mind, among others, that various aspects of the present disclosure were conceived.

### SUMMARY

One aspect of the present disclosure relates to a manufacturing tension device. The tension device may include an upper roller rotating in a first direction and comprising a series of flaps connected to and extending from the upper roller. The series of flaps of the upper roller rotate about the upper roller to provide a continuous tension to pull a sheet of material through the tension device.

Another aspect of the present disclosure relates to method for manufacturing a battery electrode. The method may include the operations of laminating an electrode stack comprising a plurality of layers using a pressing device, wherein the pressing device laminates a first solid-state electrolyte (SSE) layer and a second SSE layer to a conductive foil, removing a portion from the electrode stack, and feeding the remaining portions of the electrode stack through a tension device. The tension device may include an upper roller rotating in a first direction and comprising a series of flaps connected to and extending from the upper roller, the series of flaps applying a feeding forward force on the remaining portions of the electrode stack and a lower roller oriented opposite the upper lower rotating in a second direction, opposite the first direction, to feed the remaining portions of the electrode stack over the lower roller.

### BRIEF DESCRIPTION OF THE DRAWINGS

FIGS. 1A-1C are diagrams illustrating a solid-state anode, a solid-state cathode, and a single solid-state battery cell, according to aspects of the present disclosure.

FIG. 2 is a diagram illustrating manufacturing a solid-state electrode laminate using a calendar press, a die punch, and a tension device, according to aspects of the present disclosure.

FIG. 3 is a flowchart of a method for manufacturing a solid-state electrode laminate, according to aspects of the present disclosure.

FIG. 4 is an overhead view of a die punched electrode, according to aspects of the present disclosure.

FIG. 5A is a diagram illustrating a perspective view of a tension device for maintaining tension on remainder portions of the electrode laminate after die punching, according to aspects of the present disclosure.

FIG. 5B is a diagram illustrating a front view of the tension device for maintaining tension on remainder portions of the electrode laminate after die punching, according to aspects of the present disclosure.

FIG. 5C is a cross-section diagram of a tension device for maintaining tension on remainder portions of the electrode laminate after die punching, according to aspects of the present disclosure.

FIG. 6 is a flowchart of a method for manufacturing a solid-state electrode laminate using a tension device, according to aspects of the present disclosure.

### DETAILED DESCRIPTION

Lithium-based rechargeable batteries are used to power many forms of modern electronics and have the capability to serve as the power source for hybrid and fully electric vehicles among many other uses. State-of-the-art lithium-based rechargeable batteries typically employ a carbon-based anode to store lithium ions, such as a graphite anode. In these anodes, lithium ions are stored by intercalating between planes of carbon atoms that comprise graphite particles. Cathodes of such rechargeable batteries may contain transition metal ions, such as nickel, cobalt, and aluminum, among others. Such electrodes have been tailored to confer acceptable performance in modern lithium-ion batteries. However, carbon-based anodes are reaching maturity in terms of their lithium-ion storage.

Traditional electrode manufacturing for lithium-based rechargeable batteries can be a time-consuming and inefficient process. To manufacture a solid-state graphite anode, for example, a graphite slurry is produced that includes graphite components, binders, and a solvent that is then applied to a metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode construction may occur in a similar manner with an aluminum foil used.

The process of manufacturing such a battery electrode may introduce inefficiencies or opportunities for flaws to be introduced in the battery design, resulting in shorter battery life or potential for a short within the battery itself. For example, one or more layers of the electrode may be quite delicate and may tear or break if handled roughly. Further, the graphite slurry coated onto the metal foil may attach to the foil such that separation of the graphite from the foil may be difficult, particularly without damaging other layers of the battery stack. As such, tremendous care is typically required in the manufacturing and handling of battery electrodes to prevent damaging one or more layers of the electrode stack.

It is with these observations in mind, among other, that aspects of the present disclosure were conceived.

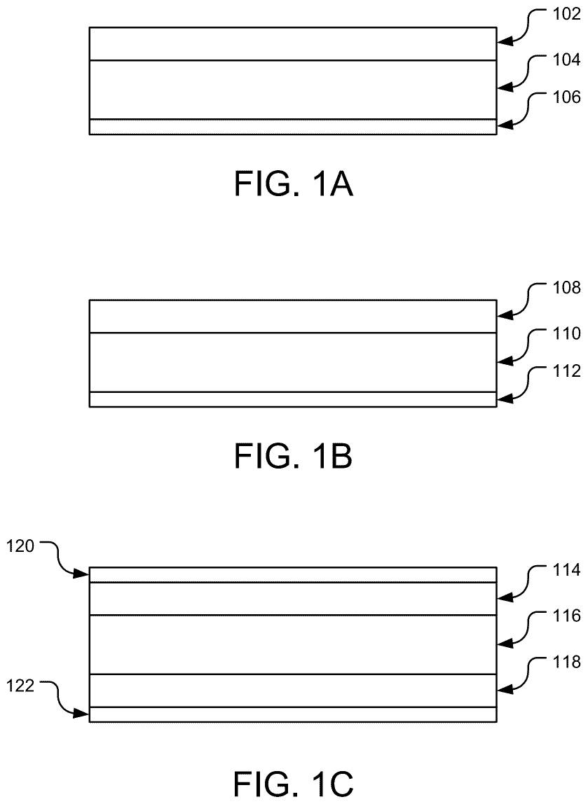

Aspects of the present disclosure involve systems and methods of producing an electrode laminate for a battery that includes a solid-state separator layer that may replace a distinct separator layer and liquid electrolyte used in conventional liquid electrolyte battery architectures. The composition of the electrode may take many forms. For example, an anode electrode, as illustrated in FIG. 1A, may comprise a stack of an electrode layer 102, a solid-state electrolyte (SSE) layer 104, and an outer carrier film 106 (such as an aluminum foil layer), which is removed prior to use in a cell. In some implementations, the electrode layer 102 may be a center electrode between two SSE layers 104. For example, the center electrode layer may be a lithium foil and the layers may be arranged initially in an Aluminum-SSE-Lithium-SSE-Aluminum layer stack. In another implementation, the center electrode layer may be an aluminum foil, copper foil, or other metallic conductive layer.

In another example, a cathode electrode, illustrated in FIG. 1B, may comprise a aluminum electrode layer 108, coated on one or both sides with a separator material 110 and an outer carrier film 112 (such as an aluminum foil layer), which is removed prior to use in a cell. In some implementations, the SSE layer 110 may comprise a sulfide-based solid-electrolyte material and a binder cast onto the aluminum carrier foil. The SSE layer 110 is cast onto an aluminum foil, which may be a sheet of material and considered a carrier that allows for volume production in conjunction with the lithium foil layer.

The anode and the cathode electrodes may be combined into an electrode stack to create a cell of a battery. For example, FIG. 1C illustrates a single battery cell that includes an anode layer 114 and a cathode layer 118, separated by an SSE layer 104, as described above. A first current collector layer 120 may be adjacent the anode layer 114 and a second current collector layer 122 may be adjacent the cathode layer 118. Other configurations of the anode electrode and the cathode electrode and the solid-state electrolyte layer are also contemplated. For example, an SSE layer 116 may be located on both sides of the anode 114 and/or the cathode 118, in some implementations. Still other configurations are possible.

Regardless of if the manufactured electrode is an anode electrode or a cathode electrode, the stack may be laminated by a calendar press device comprising a first roller and a second roller. The rollers exert a compressive force on the stack to press the layers together reducing the porosity of one or more of the materials within the stack (otherwise known as densifying), enhancing material contact, and causing layers to laminate or otherwise bond. In the case of either an anode or cathode stack, at least some layers of the respective stacks may be formed on a sheet, which may also be continuous. As such, in many cases the collective layers of the respective stacks define a layered sheet of some width. Following the calendar press, an electrode stack (either the anode or the cathode) may be continuously fed through a peeling device. The peeling device is configured to peel the carrier layer, e.g., the outer aluminum layer, from the stack to expose a collection of layers that form the electrode, which may be further processed into discrete electrode sections for use in a battery cell. Other embodiments of the continuous electrode stack do not include an outer carrier layer and, thus, are not peeled. In general, the outer layer of the stack may include many types of materials, including but not limited to metal foils such as stainless steel, nickel, copper, etc. In some cases, such as copper, the sulfide electrolyte may react with the metallic copper. Thus, these type of foils may use a coating such as a carbon coating on their surface. In other examples, the outer layer may also be non-metallic foils such as mylar, polypropylene, etc. Carbon fiber may also be used as the outer layer of the stack. Regardless of how the carrier is removed, it is removed.

Irrespective of the process of producing a particular electrode stack, aspects of the present disclosure may include a tension device to maintain tension on the electrode stack as the stack is cut, which may be in a continuous type process, into a shape for use in one or more battery configurations. More generally, aspects of the present disclosure may include a tension device for use in manufacturing of any kind of device that includes using thin sheets of fragile material, such as a thin metal foil. Although discussed herein as for use in manufacturing a battery electrode, the tension device may be utilized in any manufacturing wherein a fragile, thin material is moved along a conveyance system. As described herein, the electrode stack may be very delicate due to a general thinness of the stack (around 107 to 170 microns thick) and the densification of the layers by the calendaring process. Thus, the tension device may provide a delicate balance of tension to pull the very delicate electrode stack sheet as it is being cut or not, without causing the electrode stack to tear (too much tension or pulling) or bunch (too little tension or pulling).

In one embodiment, the tension device may include a first roller (or upper roller) and a second (or lower roller). When an electrode is cut from a sheet, there is a remaining surrounding web of material from which the electrode is cut. The remaining portion, the web or “skeleton” of the electrode stack, following the cutting operation, is fed between the rollers. The upper roller may rotate in a counterclockwise direction as the lower roller rotates in a clockwise direction to pull or otherwise draw the skeleton of the stack through the tension device. A collection of spaced flexible and resilient flaps may be connected to the upper roller and may rotate with the upper roller. A contacting edge of each of the flaps may contact the skeleton of the stack and gently pull the skeleton through the tension device providing a relatively continuous pull on the stack as it proceeds through a cutting station. The tension device may maintain the skeleton in a flat orientation against the lower roller. In one particular embodiment, the lower roller may include one or more threaded portions to apply a lateral force, outward to the either side of the skeleton, as the skeleton passes over the lower roller to further maintain the skeleton in a flat orientation by putting a mild amount of lateral tension across the skeleton. In general, the forces applied to the skeleton may maintain a tension pulling the skeleton into the tension device and laterally across the skeleton without ripping or tearing the fragile skeleton. After passing through the tension device, the remaining portions of the electrode stack defining the skeleton web may be collected for recycling or disposal. Various implementations of the tension device are described herein.

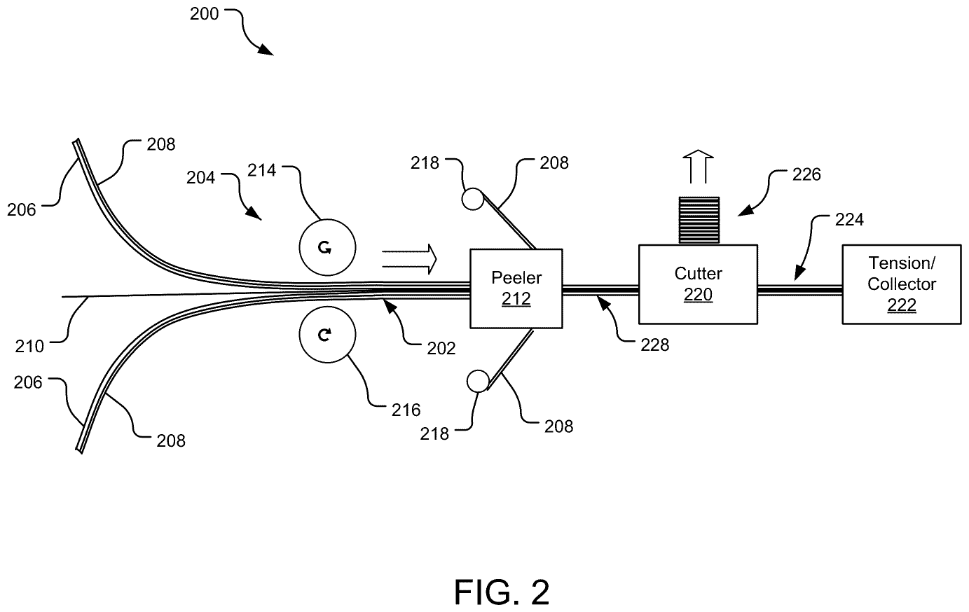

FIG. 2 is a diagram 200 illustrating manufacturing a solid-state electrode laminate 202 using a calendar press device 204, according to aspects of the present disclosure. In one implementation, the solid-state electrode laminate 202 may include two separator layers of a composite blend of a solid-state electrolyte (SSE) and a binder. The SSE 206 may be coated as a thin layer on a foil 208. In one example, the foil 208 may be an aluminum foil, although other materials may be used. A thin, metal foil 210 may be placed between two facing SSE layers 206. To generate an anode stack, two different sheets of the SSE 206 on foil 208 may be oriented such that the SSE layers are facing each other with the electrode metal layer 210 between the two SSE sheets. In this implementation, the layers forming the electrode stack 202 are fed between the calendar press 204 in a Carrier-SSE-Electrode-SSE-Carrier stack. The composite SSE layers 206 in this configuration may conduct ions, but not electrons, during use in a battery such that the SSE layers provide electrical isolation for the middle metal anode layer 210. The respective rollers of the calendar press 204 are spaced apart a distance less than the pre-calendared stack thickness such that pressure on the stack being fed between the calendar rollers 214, 216 may reduce the porosity of the materials within the stack, enhance material contact, cause some layers to bond, and/or cause a reduction in the adhesion of the SSE layers 206 to the center electrode 210 layer. The pressure exerted by the calendar rollers on the stack may be adjusted through a calendar controller, either manually or automatically, by adjusting the space between the calendar rollers among other factors, such as the density and type of material of the stack, the pre-densified thickness of the layers of the stack, and the like

The SSE layer 206 may comprise, in some implementations, a sulfide-based material that is cast onto an aluminum foil layer 208. The SSE layer 206 may also include a binder solution and/or a solvent prepared in a slurry form. When making the SSE slurry, one or more solvents may be used and the binder(s) used may or may not be soluble in those solvents. When the binder is not soluble, a “binder solution” is not formed. Also, when the SEE layer 206 is dried, there is no longer a binder solution. Rather, a solid binder that is intimately mixed within the SSE layer remains. This SSE slurry may be mixed, coated onto the aluminum foil 208, and dried. In some implementations, each of the SEE layers 206 may be between 50-100 microns thick, although other thicknesses may be used. As noted above, the SSE slurry may be coated onto an aluminum foil 208 on one side and dried. In some implementation, the aluminum foil 208 may be between 10-30 microns thick, although other thicknesses may be used.

To produce the solid-state electrode laminate 202, the layers may be fed through a calendar press device 204 in a Carrier-SSE-Electrode-SSE-Carrier layered stack. The calendar press 204 may comprise a first roller 214 and a second roller 216 between which the solid-state electrode laminate 202 may be passed. The opposing cylindrical faces of the respective rollers 214, 216 exert a compressive force on the stack 202 to press or laminate the layers together. In one implementation, the pressure exerted on the stack 202 may reduce the porosity of the materials within the stack and cause the layers to bond. For example, the calendar press 204 may cause the SSE layers 206 to bond to the center electrode layer 210. In addition, the pressure exerted on the stack 202 may cause some layers to at least partially separate, such as the outer foil layers 208 to the SSE layers 206. The pressure applied to the stack 202 may correlate to a spacing between the first roller 214 and the second roller 216, among other factors such as temperature of the stack, which may be adjustable by a controller. For example, one or both of the calendar rollers of the press 204 may be adjustable to increase or decrease the spacing between the rollers 214, 216. This densification of the stack 202 may cause the SSE layers 206 to press into the conductive layer 210 and generate adhesion between the layers. In addition, the adhesion between the SSE layers 206 and the respective carrier foil layers 208 may lessen such that the outer layer foil may be peeled from the pressed stack 202 in a controlled manner.

In some embodiments and after calendaring, the electrode stack 202 may be fed through a peeler 212 or peeling device. As described above, the calendar press 204 may partially separate the SSE layers 206 from the outer foil layer 208 during the densification of the stack by the press. However, the outer foil layer 208 may remain on the stack such that the peeler 212 may remove or peel the outer layer from the stack after pressing. The peeler 212 may include an input side into which the electrode stack, including the aluminum foil 208 outer layers, is fed. Within the peeler 212, the aluminum foil 208 layers may be peeled from or otherwise removed from the other layers of the stack 202. The peeler 212 may also include an output side in which the electrode stack 202 without the outer aluminum layers 208 may exit. In particular, the electrode stack following the peeler 212 may include two SSE layers 206 and a center conductive foil layer 210 arranged in an SSE-Center Electrode-SSE stack configuration. The removed aluminum foil layers 208 may be peeled from the stack 202 by the peeler 212 and wound around one or more aluminum collectors 218. More particularly, the aluminum collectors 218 may be motorized or otherwise operated to rotate and apply a pulling force on the aluminum foil layers 208 to peel the layers from the stack 202. The output electrode stack comprises the SSE-Center Electrode-SSE compressed layers, which may be utilized as an anode in a solid-state battery or other possible uses. One particular peeling device is disclosed in co-filed U.S. Provisional Patent No. 63/413,532, the entirety of which is incorporated by reference herein. Other electrode compositions may also be manufactured using the same or similar system 200.

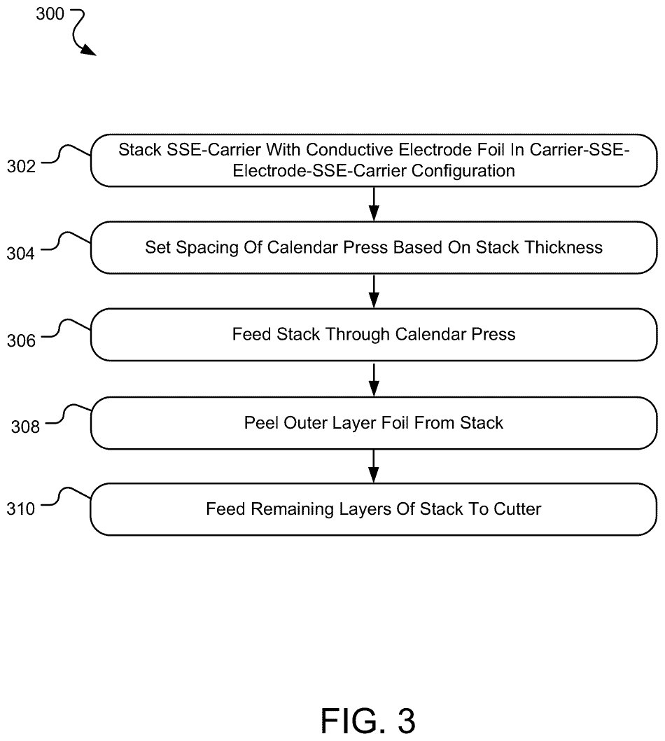

FIG. 3 is a flowchart of a method 300 for manufacturing a solid-state electrode laminate, according to aspects of the present disclosure. Beginning at step 302, a solid-state electrolyte may be cast onto a metal foil, as described above. In one implementation, the metal foil may be an aluminum foil, although other types of foils may be used. The cast aluminum-SSE layers may be stacked with a center conductive foil 210 in a Carrier-SSE-Electrode-SSE-Carrier configuration. In some instances, the center conducting 210 layer of the stack may comprise types of conducting material, such as aluminum, lithium, or copper.

The stacked configuration may be fed through a calendar press 204 to laminate the SSE layers 206 onto the center conductive foil 210 layer. Thus, at step 304, a spacing of the calendar press 204 may be set. In one implementation, the spacing may be manually set by an operator of the press 204. In another implementation, the spacing may be controlled by a calendar press controller based on one or more inputs. Further, the spacing of the calendar press 204 may be based on the thickness of the stack 202 of materials or on the thickness of any or more of the layers of the stack. At step 306 and following the setting of the spacing of the press 204, the stack 202 may be fed through the calendar press for laminating the SSE layers 206 to the center conductive foil 210.

At step 308, the calendared electrode stack 202 may be fed into a peeler 212 and the outer layer foil 208 may be peeled from the stack by the peeler. 310, the remaining layers may be fed to a cutter device 220 for cutting into appropriate lengths or shapes for use in a battery configuration. As described above, the output of the peeler 212 may be the electrode stack 228 without the outer carrier foil 208 and include the layers for use in battery configurations. However, the electrode stack 228 exits the peeler 212 in a continuous sheet such that the stack may be cut to a particular size or shape for inclusion in the battery configurations. In one implementation, the cutter device 220 may include a die punch that stamps out the intended shape for a battery configuration and, in some implementations, extracts or separates the cut-out portion 226 from the remaining portion of the stack, often referred to as the “skeleton” 224.

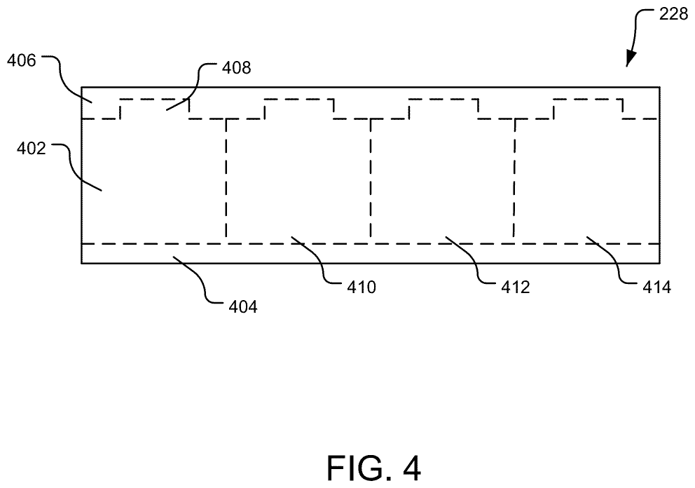

FIG. 4 illustrates is a top view of a die punched electrode cut from a solid-state electrode sheet stack, which may be produced through various aspects of the process discussed above or otherwise. As mentioned, the sheet electrode stack 228 may be cut into a particular size and/or shape for use in a battery configuration. In the example shown, the electrode stack 228 is cut along the dashed lines to obtain electrodes 402 that include a generally rectangular shape and a tab 408 portion extending from one side of the rectangle. When assembled in a battery cell, the rectangular body would be positioned with an electrolyte layer separating it from the opposing electrode. In particular, the electrode stack 228 may be fed into the cutting device 220, which may include a die punch or a stamp that cuts the stack along the dotted line to “punch out” a first electrode 414. The portion of the sheet outside the dotted lines forms the web or skeleton. The die punched electrode 414 may then be removed from the stack 228 and collected for use in battery configurations, leaving the skeleton.

As shown in FIG. 2, the die punched electrodes 226 may exit the cutter 220 in a stacked formation, although the electrodes may be removed from the cutter device 220 through any technique. Following the cutting of the first electrode 414, the stack 220 may then be fed through the cutter into a position in which a second electrode 412 may be cut or die punched, and so on. In this manner, multiple electrodes 410-414 may be cut from laminated electrode stack 228 discussed above for use in multiple battery cells.

The cutter 220 separates the electrode stack 228 into multiple portions. In particular, the electrode 228 may include a cut electrode portion 402, a first leftover or “skeleton” portion 404 along one edge of stack, and a second leftover portion 406 along a second edge of the stack. In the example shown, each cut electrode is immediately adjacent the next electrode. However, it possible that there will be some separation between electrodes thereby forming a lateral portion of the skeleton between each electrode and between the upper and lower portions of the skeleton. As mentioned, the shape and size of the electrode 402 may vary based on the battery configuration for which the cut electrode 402 is to be used such that the shape of the skeleton portions 404, 406 may also vary in response to the different die punch electrode shapes. In general, however, some portion along both outer edges of the electrode stack 228 may remain after the electrode 402 is cut from the stack.

Due to the much smaller surface area of the skeleton portions 404, 406, the skeleton is much more delicate than the uncut stack 228. This fragility of the skeleton 404, 406 makes attempts to apply a pulling force to the cut skeleton difficult. There is also a degree of resistance imparted by the uncut portion of the sheet prior to it being fed into the cutter. Too much pulling force may cause the thin skeleton to rip while too little pulling force may not remove the skeleton from the cutter 220 to feed the stack 228 through the cutter for the next electrode to be cut. One implementation may comprise a wider stack 228 to increase the surface area of the remaining skeleton. Increasing the width of the stack 228 may provide more mechanical robustness to the skeleton and allow for the skeleton to withstand a larger tension from pulling without causing the skeleton to wrinkle or tear. However, using a wider stack 228 may increase the cost of manufacturing and the overall waste produced in processing. Thus, a tension device 222 may be utilized to provide enough pulling force to pull the cut stack 224 through the cutter 220 but does not apply enough force to cause the cut stack 224 to tear or wrinkle.

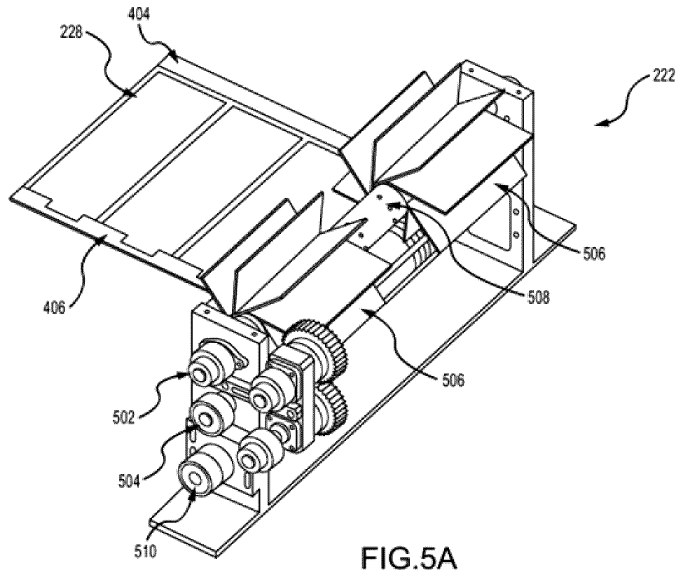

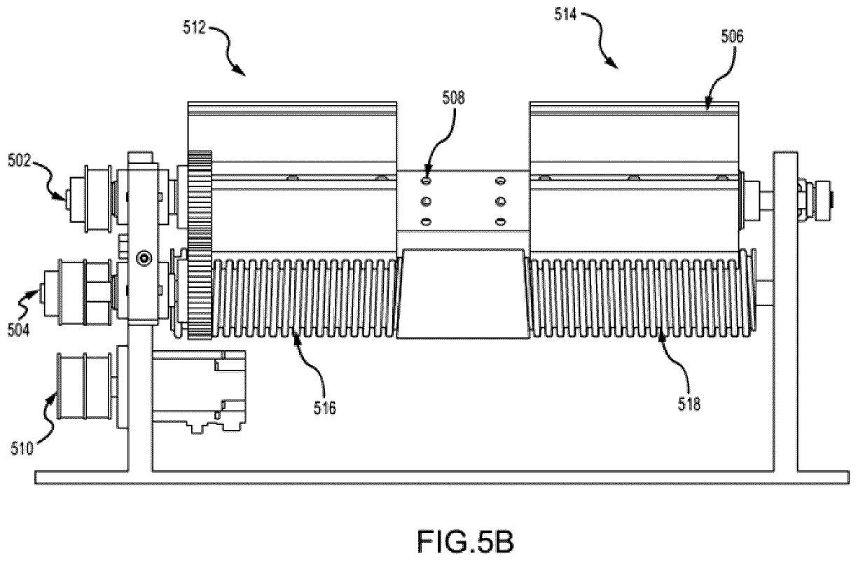

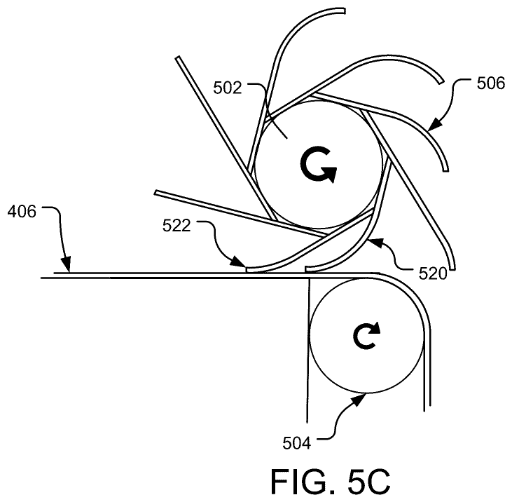

FIG. 5A is a diagram illustrating a perspective view of one embodiment of a tension device and FIG. 5B is a front view of the same embodiment of the tension device. As noted, a tension device 222 maintains tension, laterally and or longitudinally, on remainder portions of the electrode laminate after it has been cut to form discrete electrodes. The tension device 222 may include an upper roller 502 configured to rotate in a counterclockwise direction and a lower roller 504 configured to rotate in a clockwise direction. The skeleton portions 404, 406 of the electrode stack 224 (after die punched to remove the electrode portion) may be fed between the upper roller 502 and the lower roller 504, such that the upper and lower rollers are spaced far enough apart to produce a gap wide enough for the skeleton of the punched stack 228 to pass through. In one implementation, the upper roller 502 and the lower roller 504 may be rotated by the same actuator device 510, such as a rotating motor assembly. A series of gears and/or belts may be in mechanical communication with the actuator device 510 to drive the rotation of the upper roller 502 and lower roller 504. In another implementation, the upper roller 502 and the lower roller 504 may be rotated by separate actuators.

In some implementations, a plurality of flaps 506 may be connected to and extend from the upper roller 502. In particular, a first edge of each flap 506 may be connected to the upper roller 502 through one or more mounting holes 508 located on the outer surface of the upper roller 502. In some implementations, each flap 506 may connect to the upper roller 502 at a portion of the flap other than the edge, such as some distance along the flap from each edge of the flap. For example, and as shown in FIG. 5C, the flaps 506 connect to the upper roller such that some portion of each flap extend in both directions from the connection point. The flaps 506 may include any number of flaps disposed about the upper roller 502. The flaps may or may not be equally spaced apart around the upper roller 502. In one particular implementation, eight such flaps may be connected to the upper roller 502 equally spaced about the circumference of the upper roller. As explained in more detail below, the flaps 506 may contact and guide the skeleton 404, 406 of the stack 224 through the gap between the upper roller 502 and the lower roller 504 for collection as leftover portions of the electrode production process. Thus, in some instances, the number and spacing of the flaps may be positioned such that at least one of the flaps maintains contact with the electrode skeleton 404, 406 during rotation of the upper roller 502 to aid in feeding the skeleton through the tension device 222. For example, FIG. 5C is a diagram illustrating a side view of the tension device 222 for maintaining tension on remainder portions of the electrode laminate after die punching. As illustrated, a first flap 520 and a second flap 522 may be in contact with the skeleton 406 as the upper roller 502 is rotated. The flaps 506 may be spaced apart such that at least one of the flaps is in contact with the skeleton 406 at all times during rotation of the upper roller 502. In this manner, the spacing of the flaps 506 may be such that a constant pulling force on the skeleton is maintained. In some instances, the flaps 506 may be constructed from a Polyolefin type polymer such as polypropylene, polyethylene, polymethylpentene, polybutene-1, ethylene-octene copolymers, stereo-block, olefin block copolymers, propylene-butane copolymers. The flaps may also be constructed from polyolefin elastomers such as polyisobutylene, poly (a-olefin) s, or ethylene propylene rubber.

To mount the flaps 506 to the upper roller 502, a connector may pass through the first edge of each flap 506 and one or more respective mounting holes 508 of the upper roller 502. The flaps 506 may or may not be rigidly mounted to the upper roller 502. For example, the flaps 506 may be configured to bend at or near the first edge such that the angle of the flap may change in relation to the outer surface of the upper roller 502 as the flap is rotated along with the upper roller, as illustrated in FIG. 5C. For example, the flaps 506 may attach to the upper roller 502 through a hinge mechanism that allows the flaps to rotate about the hinge as the upper roller rotates. In another example, the flaps 506 may include a flexible portion at or near the edge in connection to the upper roller 502 to allow the flaps to bend along the flexible edge in response to gravity as the upper roller is rotated. In yet another example, the flaps 506 may be rigidly attached to extend from the upper roller 502 at some angle, including perpendicular to the outer surface of the upper roller.

In some instances, the flaps may include a width substantially similar to the length of the upper roller 502 such that a single group of flaps may be connected to the upper roller. In other instances, a separate group of flaps 506 may be connected to the upper roller 502. In the example illustrated in FIGS. 5A and 5B, the tension device 222 includes left-side flaps 512 and right-side flaps 514. The left-side flaps 512 may be connected to and oriented on the upper roller 502 to contact and aid in feeding a first portion 404 of the skeleton though the tension device 222 and the right-side flaps 514 may be connected to and oriented on the upper roller to contact and aid in feeding a second portion 406 of the skeleton though the tension device. In particular, as the upper roller 502 rotates, the left-side flaps 512 are similarly rotated about the upper roller. The flaps 506 may contact the first portion 404 of the skeleton to guide the skeleton between the upper roller and the lower roller 504. The pulling force applied by the left-side flaps 512 may be enough to maintain a tension on the first portion 404 of the skeleton as the portion is fed through the tension device 222 without tearing, ripping, or pinching the first portion of the skeleton. As such, the left-side flaps 512 may be a material with a sufficient coefficient of friction to provide the adequate pulling force on the skeleton portion 404 as the flap contacts the portion without damaging the portion. In one implementation, the left-side flaps 512 may be made from a vinyl plastic material. However, the left-side flaps 512 may be made from any material with a proper coefficient of friction. In some examples, the coefficient of friction between a flap and the top of the electrode layer may be between 0.10-0.50. For comparison, flaps composed of polyethene may have a coefficient of friction of around 0.14 and flaps composed of polypropylene may have a coefficient of friction of around 0.28.

The right-side flaps 514 may operate in a similar manner as the left-side flaps. For example, as the upper roller 502 rotates, the right-side flaps 514 are similarly rotated about the upper roller. The flaps 506 on the right-side of the upper roller 502 may contact the second portion 406 of the skeleton to guide the skeleton between the upper roller and the lower roller 504. The pulling force applied by the right-side flaps 514 may be enough to maintain a tension on the first portion 404 of the skeleton as the portion is fed through the tension device 222 without tearing, ripping, or pinching the first portion of the skeleton. The right-side flaps 514 may be of a similar material as the left-side flaps with a sufficient coefficient of friction to provide the adequate pulling force on the skeleton portion 406. In this manner, the left-side flaps 512 and the right-side flaps 514 may be rotated by the upper roller 502 to gently pull the skeleton of the electrode stack through the tension device 222.

The tension device 222 may also include the lower roller 504 to further aid the feeding of the skeleton of the electrode through the tension device 222. As best seen in FIG. 5B, the tension device 222 may include a gap between the upper roller 502 and the lower roller 504 through which the skeleton of the electrode stack may be fed. In one implementation, the gap between the upper roller 502 and the lower roller 504 may be adjustable to accommodate thicker electrode stacks. In general, the gap between the upper roller 502 and the lower roller 504 may be large enough to allow the skeleton to be fed between the rollers.

In addition, the lower roller 504 may include threads cut into the outer surface of the lower roller. In some instances, the lower roller 504 may include a first screw section 516 comprising left-handed spiraling and a second screw section 518 comprising right-handed spiraling. The left-handed spiraling of the first screw section 516 may produce a pulling force to the left of the center of the lower roller 504 as the lower roller is rotated. Similarly, the right-handed spiraling of the second screw section 518 may produce a pulling force to the right of the center of the lower roller 504 as the lower roller is rotated. As the skeleton portions 404, 406 of the electrode stack is fed between the upper roller 502 and the lower roller 504, the threaded portions 516, 518 of the lower roller may provide a lateral force across the respective skeleton portion to maintain the skeleton in a flat position over the lower roller. In some instances, the angle of the threaded sections 516, 518 of the lower roller 504 may be adjusted to provide more or less lateral forces across the skeleton to ensure the skeleton portions do not bunch toward the center or away from the center of the tension device 222. Further, in some instances the lower roller 504 may be constructed from same or similar material as the flaps 506 of the upper roller 502. Alternatively, the threaded portions 516, 518 of the lower roller 504 may be coated with the same or similar material as the flaps 506. In still other implementations, the threaded portions 516, 518 of the lower roller 504 may be constructed with a different material as the flaps 506, which may or may not have a similar coefficient of friction. In general, the lower roller 504 may provide a gentle pulling force on the skeleton portions 404, 406 of the electrode stack to feed the portions between the upper roller and the lower roller.

The tension device 222 may include additional features to aid feeding the electrode skeleton portions 404, 406 between the upper roller 502 and the lower roller 504 to maintain a pulling force on the electrode stack after cutting. In one implementation, the angle at which the flaps 506 are mounted onto the upper roller 502 may be altered. For example, the flaps 506 as illustrated in FIGS. 5A-5C are mounted parallel to the axis of the upper roller 502. However, the flaps 506 may be mounted on the upper roller 502 at an angle to the axis of the upper roller 502, such as 80 degrees, 60 degrees, 45 degrees, etc. In general, the arrangement of the flaps 506 may be such that they are angled on the upper roller 502 to generate a lateral force across the skeleton portions 404, 406, either away from or toward the center of the upper roller. For example, the left-side flaps 512 may be angled 45 degrees counterclockwise in relation to the axis of the upper roller 502 to provide a lateral force away from the center of the upper roller as the left-side flaps contact the first portion 404 of the skeleton. In some instances, the right-side flaps 514 may be angled mirrored from the left-side flaps 512. Thus, in this implementation, the right-side flaps 514 may be angled 45 degrees in a clockwise direction from the axis of the upper roller 502. In other instances, the angle of the left-side flaps 512 and the right-side flaps 514 may be different angles, in either direction and/or degree. The angle of the flaps 506 may determine how the flaps contact the skeleton 404, 406 and the magnitude and direction of forces placed on the skeleton. For example, having the flaps angled may not only pull the skeleton portions 404, 406 through the gap between the upper roller 502 and the lower roller 504, but may also produce a lateral force to the left and/or right of center to deter or prevent the skeleton portions from scrunching or buckling prior to being fed through the gap. Adjustment to the forces applied to the skeleton by the angled flaps 506 may be made through different attachments of the flaps to the upper roller 502.

The flaps 506 illustrated FIGS. 5A-5C have a flat edge that contacts the skeleton as the flaps are rotated around the upper roller 502. However, in other implementations, the edge of the flaps 506 that contact the skeleton may include one or more perforations along the edge of the flaps contacting the skeleton. For example, the contacting edge of the flaps 506 may include one or more portions that are removed. The missing portions may reduce the overall coefficient of friction of the flap 506 as it contacts and applied a pulling force on the skeleton 404, 406. In this manner, the flaps 506 may be constructed with various types of materials and the pulling force on the skeleton may be adjusted by removing one or more portions of the contacting edge of the flaps 506 to prevent the flaps from tearing or otherwise impeding the feeding of the skeleton through the tension device 222.

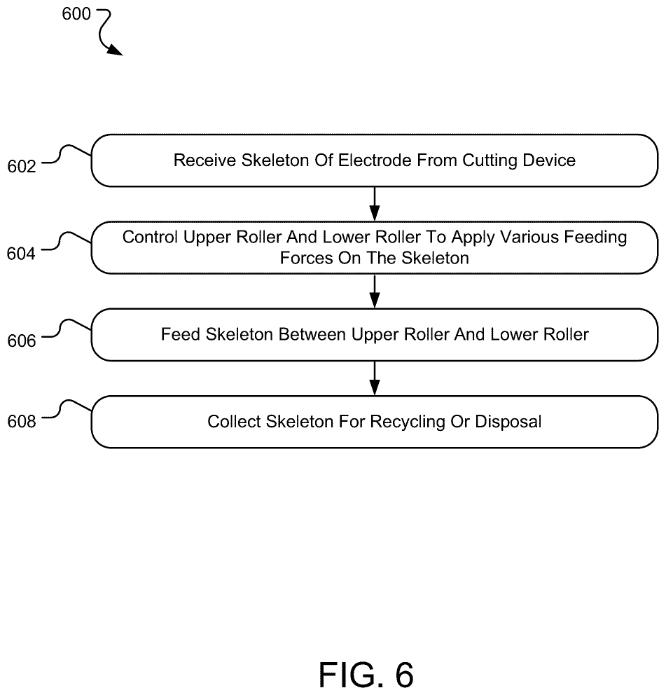

FIG. 6 is a flowchart of a method 600 for manufacturing a solid-state electrode laminate using a tension device 222. In particular, the operations of the method 600 may be performed by a controller of the tension device 222 to feed the skeleton of the electrode stack 224 after the electrode has been cut into one or more shapes for use in a battery configuration. The tension device 222 may provide a pulling force on the remaining skeleton portions 404, 406 to maintain feeding of the electrode stack through the cutting device 220. Further, the tension device 222 may provide the skeleton portions 404, 406 to a repository, such as a recycling system or other collection system. In operation 602, the tension device 222 may receive the skeleton 224 of the electrode stack after one or more portions of the stack have been cut by the cutting device 220. As described above, the skeleton 224 may include a first portion 404 and a second portion 406 at the outer edges of the electrode stack, although other portions of the electrode stack may remain after cutting.

At operation 604, the upper roller 502 and the lower roller 504 may be controlled to rotate to apply various forces on the received skeleton 224. In one example, the upper roller 502 and the lower roller 504 may be controlled separately. In another example, the upper roller 502 and the lower roller 504 may eb controlled by the same actuating device. Further, the rollers 502, 504 may be controlled to rotate at a faster speed than the rate at which the skeleton 224 is fed into the tension device 222. In one particular implementation, the rollers 502, 504 of the tension device 222 may rotate approximately 10% faster than the skeleton 224 is fed from the cutter 220. Rotation of the rollers 502, 504 of the tension device 222 may be controlled to be faster than the rate at which the skeleton 224 is fed through the tension device 222 to drag the flaps 506 across the skeleton to apply the forward and lateral forces across the skeleton to aid in the skeleton remaining flat as the skeleton is fed between the upper roller and the lower roller. In general, however, the rotation of the upper roller 502 and the lower roller 504 may be any speed in relation to the rate at which the skeleton is fed through the tension device 222.

At operation 606, the rotation of the upper roller 502 and/or the lower roller 504 may cause the skeleton 224 to be fed through the tension device 222. More particularly, the flaps 506 connected to the upper roller 502 may provide a forward force to guide the skeleton through the gap between the rollers. The skeleton 224 may lay upon the lower roller 504 as the roller rotates, further providing the feeding force on the skeleton. One or more threaded portions of the lower roller 504 and/or the flaps 506 may also provide some lateral force across the skeleton. At operation 608, the skeleton 224 may be collected for recycling or disposal after passing between the upper roller 502 and the lower roller 504. For example, the skeleton 224 may be directed into a collection bin after passing through the tension device 222 for recycling or disposal. In other implementations, the skeleton 224 may be wound around a collection spool for recycling or disposal. In general, the tension device 222 is configured to maintain the tension on the skeleton 224 post-cutting of the electrode stack such that the stack may continue to be fed through the cutting device 220 to prevent bunching or other conditions of the stack that may impede the progression of the stack through the cutting device.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Embodiments of the present disclosure include various operations, which also may be referred to as steps, which are described in this specification. The operations may be performed by or involve hardware components or may be embodied in machine-executable instructions, which may be used to cause a general-purpose or special-purpose processor programmed with the instructions to perform the operations. Alternatively, the operations may be performed by a combination of hardware, software and/or firmware.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly and synonymously “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others. The disclosure is not limited to various embodiments (examples, instances or aspects) given in this specification. Various modifications and additions can be made to the exemplary embodiments discussed without departing from the scope of the present invention. Accordingly, the scope of the present invention is intended to embrace all such alternatives, modifications, and variations together and in various possible combinations of various different features of different embodiments combined to form yet additional alternative embodiments, with all equivalents thereof.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term.

Without intent to limit the scope of the disclosure, examples of instruments, apparatus, methods and their related results according to the embodiments of the present disclosure are given. Note that titles or subtitles may be used in the various embodiments for convenience of a reader, which in no way should limit the scope of the disclosure.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

What is claimed is:

1. A manufacturing tension device comprising:
a first roller rotating in a first direction and comprising a plurality of flaps positioned around a circumference of the first roller; and
wherein the upper roller rotates to cause the plurality of flaps to provide a continuous tension to pull a sheet of material through the tension device.

2. The manufacturing tension device of claim 1 wherein the sheet of material is a skeleton of a cut electrode for a battery.

3. The manufacturing tension device of claim 2, wherein the plurality of flaps comprises a first set of flaps to contact a first portion of the skeleton of the cut electrode stack and a second set of flaps, separate from the first set of flaps, to contact a second portion of the skeleton of the cut electrode stack.

4. The manufacturing tension device of claim 2, wherein the plurality of flaps are positioned around the circumference of the first roller such that at least one of the plurality of flaps is in contact with the skeleton of the cut electrode during a rotation of the first roller to provide a consistent pulling force on the skeleton.

5. The manufacturing tension device of claim 2, wherein the flaps comprise a straight contacting edge to contact the skeleton of the cut electrode stack.

6. The manufacturing tension device of claim 2, wherein the flaps comprise a perforated contacting edge to contact the skeleton of the cut electrode stack.

7. The manufacturing tension device of claim 1, wherein the flaps are connected to the first roller substantially parallel to an axis of the first roller.

8. The manufacturing tension device of claim 2, wherein the plurality of flaps are connected to the first roller angled in relation to an axis of the first roller.

9. The manufacturing tension device of claim 8, wherein the angled flaps apply a forward force and a lateral force across the skeleton of the cut electrode stack.

10. The manufacturing tension device of claim 2, wherein the plurality of flaps contacting the skeleton of the cut electrode stack applies a feeding force to the skeleton without tearing or bunching the skeleton.

11. The manufacturing tension device of claim 2 further comprising:
a lower roller oriented opposite the upper lower rotating in a second direction, opposite the first direction to feed a skeleton of a cut electrode stack over the lower roller;
wherein the upper roller rotates to cause the plurality of flaps to pull the skeleton of the cut electrode stack and feed the skeleton over the second roller.

12. The manufacturing tension device of claim 11, wherein the second roller comprises a threaded portion to apply a lateral force across the skeleton of the cut electrode stack.

13. The manufacturing tension device of claim 12, wherein the threaded portion comprises a clockwise-threaded portion to apply a rightward lateral force across the skeleton of the cut electrode stack and a counterclockwise-threaded portion to apply a leftward lateral force across the skeleton of the cut electrode stack.

14. The manufacturing tension device of claim 11 further comprising an actuator to rotate the first roller in the first direction and the second roller in the second direction.

15. The manufacturing tension device of claim 1, wherein the electrode stack comprises, an upper solid-state electrolyte (SSE) layer, a conductive foil, and a lower SSE layer.

16. A method comprising:
laminating an electrode stack comprising a plurality of layers using a pressing device, wherein the pressing device laminates a first solid-state electrolyte (SSE) layer and a second SSE layer to a conductive foil;
removing a portion from the electrode stack; and
feeding the remaining portions of the electrode stack through a tension device comprising:
a first roller rotating in a first direction and comprising a plurality of flaps positioned around a circumference of the first roller, the plurality of flaps applying a feeding forward force on the remaining portions of the electrode stack; and
a second roller oriented opposite the first lower rotating in a second direction, opposite the first direction, to feed the remaining portions of the electrode stack over the second roller.

17. The method of claim 16, wherein the plurality of flaps comprises a first set of flaps to contact a first portion of the skeleton of the cut electrode stack and a second set of flaps, separate from the first set of flaps, to contact a second portion of the skeleton of the cut electrode stack.

18. The method of claim 17, wherein the plurality of flaps are positioned around the circumference of the first roller such that at least one of the plurality of flaps is in contact with the skeleton of the cut electrode during a rotation of the first roller to provide a consistent pulling force on the skeleton.

19. The method of claim 17, wherein the flaps comprise a straight contacting edge to contact the skeleton of the cut electrode stack.

20. The method of claim 17, wherein the flaps comprise a perforated contacting edge to contact the skeleton of the cut electrode stack.
